(19) United States
(12) Patent Application Publication
(10) Pub. No.: US 2025/0365385 A1
(43) Pub. Date: Nov. 27, 2025

(54) IMAGE PROCESSING APPARATUS, IMAGE PROCESSING METHOD, AND MEDIUM

(71) Applicant: CANON KABUSHIKI KAISHA, Tokyo (JP)

(72) Inventors: MASAAKI OBAYASHI, Kanagawa (JP); SHINICHI MIYAZAKI, Kanagawa (JP); FUMINO MATSUI, Kanagawa (JP); AKITOSHI YAMADA, Kanagawa (JP); HISASHI ISHIKAWA, Chiba (JP)

(21) Appl. No.: 19/214,701

(22) Filed: May 21, 2025

(30) Foreign Application Priority Data
May 27, 2024 (JP) 2024-085653

(51) Int. Cl. H04N 1/60; G06T 3/40

(52) U.S. Cl. CPC H04N 1/6019; G06T 3/40; H04N 1/6058

(57) ABSTRACT

An image processing apparatus is configured to detect one or more regions each of which has a predetermined size configured by pixels of the same color from image data, store color information of a color included in each of the one or more regions detected, and generate output image data by performing color conversion of the image data using a first color conversion table in a case where the color information stored indicates one color, and generate output image data by performing color conversion of the image data using a second color conversion table in a case where the color information stored is two or more colors. Color conversion using the second color conversion table results in a larger color difference between at least two colors in the color information than color conversion using the first color conversion table.

### BACKGROUND OF THE DISCLOSURE

### Field of the Disclosure

The present disclosure relates to an image processing apparatus that can execute color mapping, an image processing method, and a medium.

### Description of the Related Art

A known printer receives a digital document described in a predetermined color space, performs mapping for each color in the color space to a color reproduction region that can be reproduced by a printer, and outputs this.

For example, in a known method (Japanese Patent Laid-Open No. 2024-008263), an object in a document is identified, “colorimetric” mapping is performed in a graphic region, and “perceptual” mapping is performed in a photo region. However, in a case where “perceptual” mapping is performed, the chroma may be degraded even if the color is reproducible by a printer in the color space of the digital document. Also, in a case where “colorimetric” mapping is performed, if a color is present that is outside of the color gamut of the printer from among the plurality of colors included in the digital document, the mapping may cause color degeneration.

As a countermeasure, in the method according to Japanese Patent Laid-Open No. 2024-008263, the distance between colors of colors susceptible to color degeneration is increased so that color mapping to a print color gamut is appropriately performed to reduce the degree of color degeneration.

However, setting a color conversion method using the pixel values of a partial document as described in Japanese Patent Laid-Open No. 2024-008263 can make it hard to increase the distance between colors for all of the pixel values if there are many colors susceptible to color degeneration, meaning that an appropriate color conversion result may not be obtained.

### SUMMARY OF THE DISCLOSURE

The present disclosure obtains an appropriate color conversion result by setting an appropriate color conversion method on the basis of color information required to set a color conversion method of an image region.

According to one aspect of the present disclosure, an image processing apparatus comprising: at least one memory storing instructions; and at least one processor that is in communication with the at least one memory and that, when executing the instructions, cooperates with the at least one memory to execute processing, the processing including detecting, from image data, one or more regions each of which has a predetermined size configured by pixels of the same color, storing color information of the color included in each of the one or more regions detected, and generating output image data by performing color conversion of the image data using a first color conversion table in a case where the color information stored indicates one color, and generating output image data by performing color conversion of the image data using a second color conversion table in a case where the color information stored indicates two or more colors, wherein color conversion using the second color conversion table results in a larger color difference between at least two colors in the color information than color conversion using the first color conversion table is provided.

According to the configuration described above, an appropriate color conversion result can be obtained by setting an appropriate color conversion method on the basis of color information required to set a color conversion method of an image region.

Further features of the present disclosure will become apparent from the following description of exemplary embodiments with reference to the attached drawings.

### BRIEF DESCRIPTION OF THE DRAWINGS

FIG. 1 is a block diagram illustrating the configuration of an image processing apparatus.

FIG. 2 is a diagram schematically illustrating the configuration of a printing apparatus.

FIG. 3 is a flowchart illustrating printing processing in the printing apparatus.

FIGS. 4A and 4B are diagrams for describing partial image data.

FIG. 5 is a flowchart for describing color conversion processing according to a first embodiment.

FIGS. 6A and 6B are diagrams illustrating image data according to the first embodiment.

FIGS. 7A, 7B and 7C are diagrams schematically illustrating color degeneration correction.

FIGS. 8A and 8B are diagrams for describing setting of a region according to the first embodiment.

FIGS. 9A and 9B are diagrams for describing a first region and a second region according to the first embodiment.

FIG. 10 is a flowchart for describing generating a color conversion table that does not produce color degeneration according to the first embodiment.

FIG. 11 is a flowchart for generating a color information list of the first region according to the first embodiment.

FIG. 12 is a diagram illustrating an example of the color information list of the first region according to the first embodiment.

FIG. 13 is a diagram illustrating image data according to a second embodiment.

### DESCRIPTION OF THE EMBODIMENTS

Hereinafter, embodiments will be described in detail with reference to the attached drawings. Note, the following embodiments are not intended to limit the scope of the present disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

The terminology used in the present embodiment will be defined in advance as follows.

### Color Reproduction Region

Color reproduction region refers to a range of color that is reproducible in a discretionary color space. Other terms for it include a color reproduction range, color gamut, and gamut. Also, color gamut volume is used as an index representing the size of the color reproduction region. The color gamut volume is a three-dimensional volume in a discretionary color space. Chromaticity points forming the color reproduction region may be discrete. For example, a specific color reproduction region is represented by 729 points on CIE-L*a*b*, and points between them are obtained by using a known interpolation operation such as tetrahedral interpolation or cubic interpolation. In this case, as the corresponding color gamut volume, it is possible to use a volume obtained by calculating the volumes on CIE-L*a*b* of tetrahedrons or cubes forming the color reproduction region and accumulating the calculated volumes, in accordance with the interpolation operation method. The color reproduction region and the color gamut in the present embodiment are not limited to a specific color space, but in the present embodiment, an example is described in which a color reproduction region in the CIE-L*a*b* space is used. Also, the numerical value of the color reproduction region in the present embodiment indicates the volume obtained by accumulation in the CIE-L*a*b* space based on tetrahedral interpolation.

Here, the color reproduction range may be determined according to the color reproduction method, color reproduction medium, and the like or may be predetermined (for example, a standard color reproduction range).

### Gamut Mapping

Gamut mapping refers to processing to convert a certain color gamut to a different color gamut. This includes, for example, mapping an input color gamut to an output color gamut different from the input color gamut. Conversion within the same color gamut is not referred to as gamut mapping. Perceptual, saturation, colorimetric, and the like of the ICC profile are typical examples. Mapping processing may be implemented via conversion using one three-dimensional (3D) look-up table (LUT), for example. Also, after color space conversion of the color gamut of the input color space to the standard color space, mapping processing of the color gamut in the standard color space may be executed. For example, in a case where the input color space is sRGB, the color gamut in the input color space is converted to the CIE-L*a*b* color space. Processing is executed to map the color gamut of the input color space converted to the CIE-L*a*b* color space to an output color gamut in the CIE-L*a*b* color space. Mapping processing may be 3D LUT processing or may use a conversion formula, for example. Also, conversion between the input color space and the output color space may be performed simultaneously. For example, in a case where the input is the sRGB color space and the output is an RGB color space or CMYK color space unique to a printing apparatus, conversion from the input color space to the output color space may be performed together with the gamut mapping.

### Color Degeneration

In the present embodiment, color degeneration is defined as the distance between colors after mapping in a predetermined color space being less than the distance between colors before mapping when gamut mapping is performed on two discretionary colors. Specifically, in the digital document, there is a color A and a color B, and by performing mapping in the color gamut of the printer, the color A is converted to a color C and the color B is converted to a color D. In this case, color degeneration is defined as the distance between the color C and the color D being less than the distance between the color A and the color B. The distance between colors may be the Euclidean distance between two points in a color space as described below. When there is color degeneration, the colors recognized as being different in the digital document are recognized as the same color in an image reproduced by printing the image. For example, in a graph, different items are recognized by making different items different colors. When there is color degeneration, there may be negative effects such as different colors being recognized as the same color and different items in the graph being falsely recognized as the same item. The predetermined color space for calculating the distance between colors here may be a discretionary color space. For example, sRGB color space, Adobe RGB color space, CIE-L*a*b* color space, CIE-LUV color space, XYZ color system color space, xyY color system color space, HSV color space, HLS color space, or the like may be used.

### Overall Description of Image Processing Apparatus

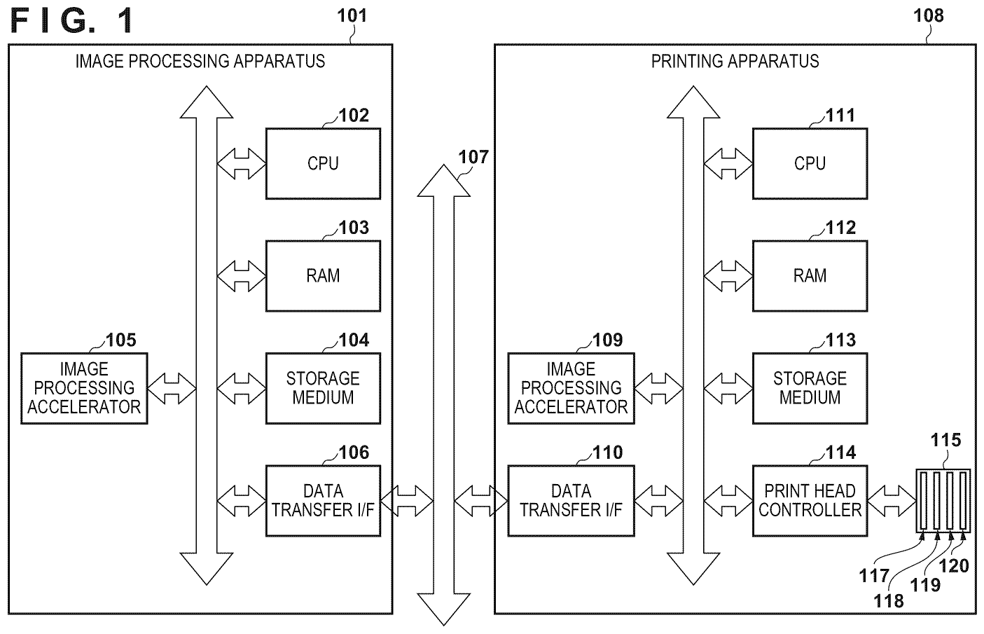

FIG. 1 is a block diagram illustrating the configuration of an image processing apparatus according to the present embodiment. A personal computer (PC), a tablet, a server, or a printing apparatus may be used as an image processing apparatus 101. A processor (CPU) 102 executes various types of image processing by loading at least one program stored in a storage medium (memory) 104, such as a hard disk apparatus (HDD) or a ROM, onto a RAM 103 serving as a working area and executing the at least one program. For example, the CPU 102 obtains a command from a user via a human interface device (HID) I/F (not illustrated). Then, the various types of image processing are executed according to the obtained command and the program stored in the storage medium 104. Also, the CPU 102 executes predetermined processing according to a program stored in the storage medium 104 on document data obtained via a data transfer interface (I/F) 106. Then, this result and/or various information is displayed on a display (not illustrated) and transmitted via the data transfer I/F 106. An image processing accelerator 105 is a piece of hardware that can execute image processing at higher speeds than the CPU 102. The image processing accelerator 105 is activated by the CPU 102 writing the parameters and data required for image processing to a predetermined address of the RAM 103. The image processing accelerator 105 executes image processing on the data after the parameters and data described above are loaded. However, the image processing accelerator 105 is not a required component, and similar processing may be executed by the CPU 102. Specifically, an image processing accelerator is a GPU or an exclusively designed electric circuit. The parameters described above may be stored in the storage medium 104 or may be obtained from the outside via the data transfer I/F 106.

In a printing apparatus 108, a CPU 111 comprehensively controls the printing apparatus 108 by loading a program stored in a storage apparatus 113 onto a RAM 112 serving as the working area and executes the program. An image processing accelerator 109 is a piece of hardware that can execute image processing at higher speeds than the CPU 111. The image processing accelerator 109 is activated by the CPU 111 writing the parameters and data required for image processing to a predetermined address of the RAM 112. The image processing accelerator 109 executes image processing on the data after the parameters and data described above are loaded. However, the image processing accelerator 109 is not a required component, and similar processing may be executed by the CPU 111. The parameters described above may be stored in the storage apparatus 113 or may be stored in a storage (not illustrated) such as a flash memory, HDD, or the like.

Here, the image processing executed by the CPU 111 or the image processing accelerator 109 will be described. The image processing is processing to generate data indicating dot formation positions of the ink for each scan by a print head 115 on the basis of the obtained print data. Also, the CPU 111 or the image processing accelerator 109 executes color conversion processing on the obtained print data and quantization processing.

Color conversion processing is processing to separate colors by the ink density handled by the printing apparatus 108. For example, the obtained print data includes image data indicating an image. The image data is image data indicating the colors by color space coordinates of sRGB or the like which are the monitor display colors, for example. In this case, the image data indicating the colors by color coordinates (R, G, B) of sRGB is converted into image data (ink data) indicating colors with the colors (CMYK) of the ink handled by the printing apparatus 108 set as element colors (component colors). The color conversion method is implemented via matrix computational processing, processing using a three-dimensional look-up table (LUT) or a four-dimensional LUT, and the like.

The printing apparatus 108 according to the present embodiment uses black (K), cyan (C), magenta (M), and yellow (Y), for example. Thus, an image data of an RGB signal is converted into image data including 8-bit color signals for K, C, M, and Y. The color signal value of each color corresponds to the applied amount of ink of each color. Also, the number of ink colors in this example is four: K, C, M, and Y. However, to improve image quality, low-density colors such as light cyan (Lc), light magenta (Lm), and gray (Gy) and other similar ink colors may be used. In this case, ink signals corresponding to these are generated.

After the color conversion processing, quantization processing is executed on the ink data. The quantization processing is processing to reduce the level numbers of tones in the ink data. In the present embodiment, quantization is performed using a dither matrix including an array of thresholds for comparing ink data values for each pixel. Via quantization, ultimately, binary data indicating whether or not to form a dot at each dot formation position is generated.

After the image processing, the generated binary data is transferred to the print head 115 by a print head controller 114. The CPU 111 performs print control to run the carriage motor for operating the print head 115 via the print head controller 114 and to run the conveyance motor for conveying the printing medium simultaneously. The print head 115 scans on the printing medium, and simultaneously, ink droplets are discharged on the printing medium by the print head 115 according to the binary data to print an image.

The image processing apparatus 101 and the printing apparatus 108 are connected via a communication line 107. In the present embodiment, a local area network is used as an example of the communication line 107. However, a USB hub, a wireless communication network using a wireless access point, a connection using a Wifi Direct communication function, or the like may be used.

In the following examples, the print head 115 includes a printing nozzle array for four colors of ink: cyan (c), magenta (m), yellow (y), and black (k). However, no such limitation is intended, and the present embodiment can be applied to a case in which image formation is performed using three colors CMY and to a case in which image formation is performing using many colors in addition to YMCK.

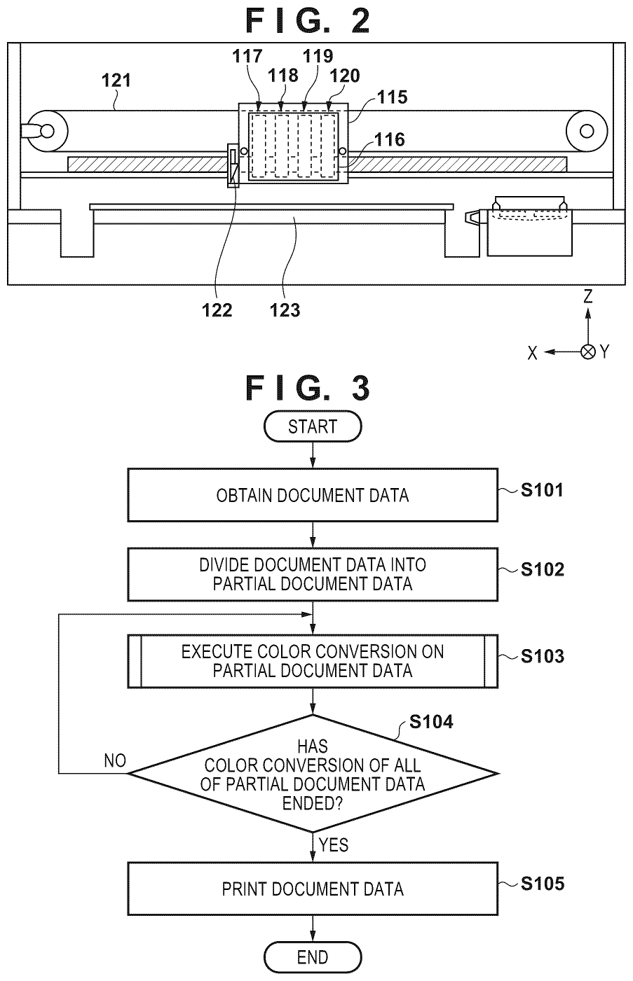

FIG. 2 is a diagram for describing the print head 115 according to the present embodiment. In the present embodiment, an image is printed by performing N number of scans for a unit region corresponding to one nozzle array. The print head 115 includes a carriage 116; nozzle arrays 117, 118, 119, and 120; and an optical sensor 122. The carriage 116 is installed with the five nozzle arrays 117, 118, 119, and 120 and the optical sensor 122 and can move back and forth in a main scan direction (X direction in the diagram) via the driving force of a carriage motor transferred via a belt 121. The carriage 116 moves in the X direction relative to the printing medium as ink droplets are discharged in the gravity direction (−Z direction in the diagram) from each nozzle of the nozzle arrays on the basis of the print data. In the present embodiment, the discharge element that discharges ink droplets from each nozzle is a thermal type that discharges ink droplets by generating air bubbles via an electrothermal conversion element. However, the configuration of the head is not limited to this, and the discharge element may use a system of discharging liquid via a piezoelectric element (piezo) or another discharge system.

Accordingly, an image corresponding to 1/N (N: natural number) of the main scan is printed on the printing medium placed on a platen 123. When one main scan is complete, the printing medium is conveyed a distance corresponding to the width of 1/N of the main scan in the conveyance direction (−Y direction in the diagram) intersecting the main scan direction. Via these operations, an image is printed by performing N number of scans in a region with a width corresponding to one nozzle array. By alternately repeating the main scan and the conveyance operation, an image is gradually printed on the printing medium. In this manner, control can be performed to complete the image printing in the predetermined region.

### Printing Processing

FIG. 3 is a flowchart illustrating printing processing in the image processing apparatus 101. The processing of FIG. 3 is implemented by the CPU 102 executing a program loaded on the RAM 103, for example. In the present embodiment, an example is described in which the printing processing is executed by the image processing apparatus 101. However, in other examples, the printing processing may be executed by the printing apparatus 108 or the processing may be shared between the image processing apparatus 101 and the printing apparatus 108.

In step S101, the CPU 102 obtains document data to be printed. Specifically, the CPU 102 obtains document data from the data transfer interface of the host PC via the data transfer interface of the image processing apparatus 101. Here, the document data is data of a writing document made of a plurality of pages.

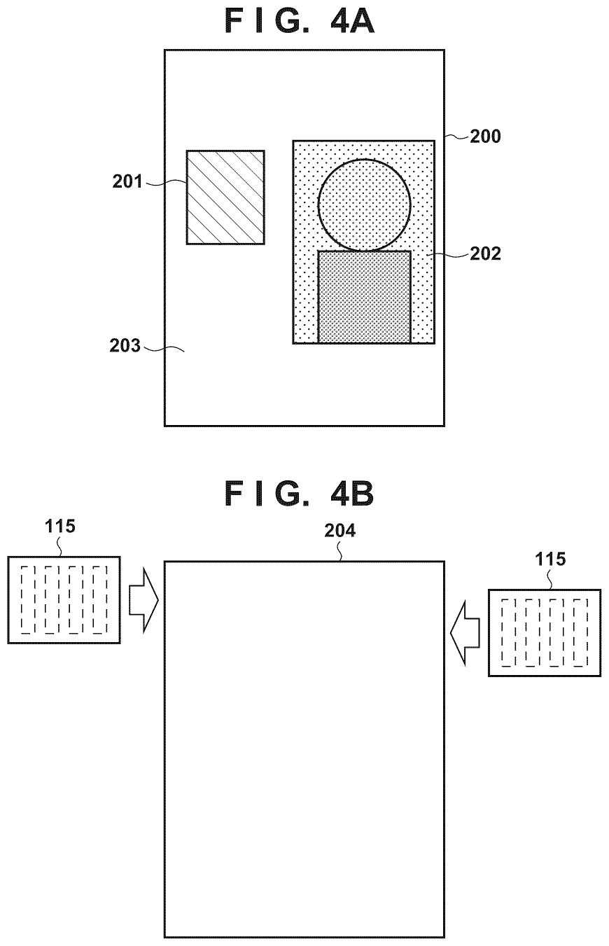

Next, in step S102, the CPU 102 divides the document data into a plurality of pieces of partial document data. In the present embodiment, the document data to be printed is data of a writing document made of a plurality of pages. The partial document data may take any form as long as the document data is divided into processing units. FIGS. 4A and 4B are diagrams for describing partial image data. For example, as with image data 200 illustrated in FIG. 4A, the page unit may be partial document data. FIG. 4B illustrates a print region for printing via scanning by the print head 115. For a region 204, printing is completed with two scans (the scanning directions indicated by arrows) of the print head 115. A unit of data printed by the print head such as the region 204 may be the partial document data. Also, in a case where the image data of FIG. 4A is described in a page description language (PDL), a region 201 or a region 202, which are region units determined by a drawing command, may be set as partial document data. Also, in the case of a page unit, for example, a plurality of region units determined by a page/band/drawing command may be collectively set as one piece of partial document data so that a first page and a second page are combined in the partial document data. In the present embodiment, an example in which the partial document data is divided on a page unit basis will be described.

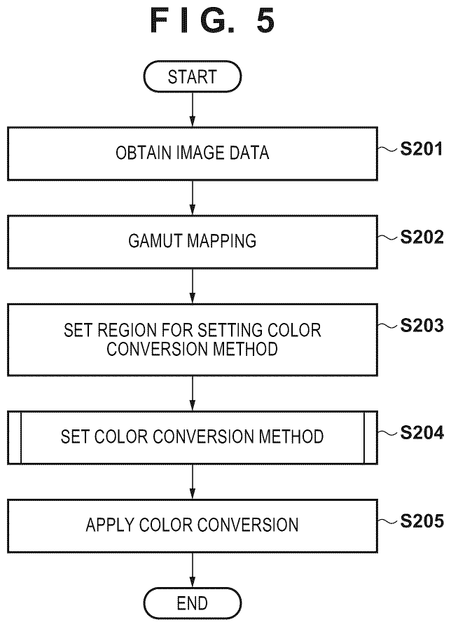

Next, in step S103, the CPU 102 executes loop processing for each piece of partial document data. In step S103, the CPU 102 executes color conversion on the partial document data. The color conversion processing will be described below in detail with reference to FIG. 5. Note that further, in step S103, the color-converted partial document data may be rendered and image data (also referred to as pixel data) configured from pixels may be generated. Note that in a case where the partial document data is divided using a drawing command as a unit, for example, if color conversion is complete for a drawing command to draw an object belonging to a predetermined region such as a page or band, rendering may be performed for the region. Note that a band is a rectangular region dividing the page in a manner parallel with the scanning direction of the print head 115 of an inkjet printing system, for example.

Next, in step S104, the CPU 102 determines whether or not the color conversion of all of the partial document data divided from the document data has ended. If it has ended, the process moves to step S105. Otherwise, the color conversion of step S103 is performed for the next partial document data.

Next, in step S105, the CPU 102 causes the printing apparatus 108 to print the document data. Specifically, the CPU 102 executes three processes, ink color separation, output characteristics conversion, and quantization, on each pixel of the image data converted in step S103, transmits the post-processing data (print data) to the printing apparatus 108, and causes the printing apparatus 108 to print.

### Ink Color Separation Processing

The ink color separation is processing to convert the output value of the color conversion processing of step S103, for example, the color value represented by Rout, Gout, and Bout, into output values of each ink color to be printed by the inkjet printing system. In the present embodiment, it is expected that four colors, cyan, magenta, yellow, and black (C, M, Y, K) are used in printing. Various methods can be used to implement color conversion, and for example, a three-dimensional LUT for each color may be used to calculate the combination of the suitable ink color pixel values (C, M, Y, K) for the combination of pixel values (Rout, Gout, and Bout) of the print data in a similar manner as in the color conversion processing. For example, the following four-dimensional LUT2 [256][256][256][4] obtained by adding the component indicating each of C, M, Y, and K to the input color components (Rout, Gout, and Bout) is used.

$$C = LUT 2 [ Rout ] [ Gout ] [ Bout ] [ 0 ] \qquad ( Formula 1 )$$

$$M = LUT 2 [ Rout ] [ Gout ] [ Bout ] [ 1 ] \qquad ( Formula 2 )$$

$$Y = LUT 2 [ Rout ] [ Gout ] [ Bout ] [ 2 ] \qquad ( Formula 3 )$$

$$K = LUT 2 [ Rout ] [ Gout ] [ Bout ] [ 3 ] \qquad ( Formula 4 )$$

Also, the grid number of the LUT may be reduced from a grid number determined by 256 values for each color of the input color component to a grid number determined by 16 values for each color, for example, to reduce the table size. In this case, a value of a grid not included in the reduced grid may be determined as an output value via interpolation of the table values.

### Output Characteristic Conversion Processing

Next, output characteristic conversion is processing to convert the density of each ink color into a print dot count ratio. Specifically, the densities of each color having 256 tones are converted into dot count ratios Cout, Mout, Yout, and Kout with 1024 tones for each color. Thus, for example, a two-dimensional LUT3 [4][256] with a suitable print dot count ratio set for the density of each ink color is used as described below.

$$Cout = LUT 3 [ 0 ] [ C ] \qquad ( Formula 5 )$$

$$Mout = LUT 3 [ 1 ] [ M ] \qquad ( Formula 6 )$$

$$Yout = LUT 3 [ 2 ] [ Y ] \qquad ( Formula 7 )$$

$$Kout = LUT 3 [ 3 ] [ K ] \qquad ( Formula 8 )$$

Also, the grid number of the LUT may be reduced from a grid number determined by 256 values for each color of the input color component to a grid number determined by 16 values, for example, to reduce the table size. In this case, a value of a grid not included in the reduced grid may be determined as an output value via interpolation of the table values.

### Quantization Processing

Next, quantization is processing to convert the print dot count ratios Cout, Mout, Yout, Kout of each ink color into an on/off for a print dot for each actual pixel. Various methods may be used for quantization including an error diffusion method, a dither method, and the like. For example, a dither method may be implemented using the following formulas.

$$Cdot = Halftone [ Cout ] [ x ] [ y ] \qquad ( Formula 9 )$$

$$Mdot = Halftone [ Mout ] [ x ] [ y ] \qquad ( Formula 10 )$$

$$Ydot = Halftone [ Yout ] [ x ] [ y ] \qquad ( Formula 11 )$$

$$Kdot = Halftone [ Kout ] [ x ] [ y ] \qquad ( Formula 12 )$$

The formulas above mean that, for each color, the print dot count ratio of a pixel position (x, y) is compared with a threshold for the pixel position (x, y), and depending on the comparison result, the value of the pixel position (x, y) is binarized to 0 or 1, for example. By comparing using a threshold in accordance with each pixel position (x, y), the on/off for the print dot for each ink color is achieved. Here, the Cout, Mout, Yout, and Kout are expressed in 10 bits and have a value range from 0 to 1023. Thus, the generation probability of each print dot is Cout/1023, Mout/1023, Yout/1023, and Kout/1023. The image data generated using Formulas 9 to 12 correspond to the print data transmitted to the printing apparatus 108.

Lastly, the image generated by transmitting the print data from the image processing apparatus 101 to the printing apparatus 108 is printed. The image in accordance with the color-converted document data is formed on a medium via a printing operation.

Note that in FIG. 3, printing is performed after the image processing for the entire document data. However, step S105 may be executed and printing performed on a page unit or band unit basis according to the processing of step S103.

### Color Conversion Processing

FIG. 5 is a flowchart for describing the color conversion processing of step S103 of FIG. 3 according to the first embodiment. The processing of FIG. 5 is implemented by the CPU 102 executing a program loaded on the RAM 103, for example. In the present embodiment, an example is described in which the color conversion processing is executed by the image processing apparatus 101. However, in other examples, the color conversion processing may be executed by the printing apparatus 108 or the processing may be shared between the image processing apparatus 101 and the printing apparatus 108. Note that in a case where the color conversion processing of step S103 is executed by the printing apparatus 108, this may be followed by the execution of steps S104 to S105 by the printing apparatus 108.

In the present embodiment, an example in which a color conversion table that can reduce color degeneration due to color conversion processing and can allow the color of the document data to be discriminated in the output of the printing apparatus is generated will be described.

In step S201, the CPU 102 obtains the partial document data that is the target of color conversion processing. The partial document data obtained according to the present embodiment is partial document data output in step S102 as described above and is document data based on page units. In the example described here, the partial document data is image data configured by pixels. The image data includes color information indicating colors defined in a predetermined color space. The color information according to the present embodiment is sRGB data. The color information is not limited thereto and as long as the color can be defined, any data format may be used including Adobe RGB data, CIE-L*a*b* data, CIE-LUV data, XYZ color system data, xyY color system data, HSV data, HLS data, and the like. The color information of the document data that is the target of color conversion processing may be referred to as the input color information. If the image data is the target of color conversion, the color information of each pixel may also be referred to as an input pixel value. The color information may be referred to as an input color component due to a plurality of color components being included. In a similar manner, post-color-conversion color information may be referred to as output color information or an output pixel value. The color information may be referred to as an output color component due to a plurality of color components being included. Also, in the description, the partial document data is image data, but this is not necessarily always the case. For example, color conversion processing may be executed on the color of a partial document data described in PDL, and thereafter, rendering may be performed to generate image data.

Next, in step S202, the CPU 102 uses a color conversion table stored in the storage medium in advance and performs color conversion on the image data. In other words, color conversion is applied to the image data via a predetermined color conversion method. The color conversion according to the present embodiment corresponds to gamut mapping of the image data, and the color reproduction region of the sRGB data is mapped to a color reproduction region of the printing apparatus via color conversion. For the printing apparatus 108, the color reproduction region is different depending on the printing method, print speed, and the like determined for each output mode. Thus, the image processing apparatus needs to perform gamut mapping in accordance with a plurality of output modes. The post-gamut-mapping image data is stored in the RAM or the storage medium. Specifically, the color conversion table is a three-dimensional LUT for each output color component. The combination of the output pixel values (Rout, Gout, and Bout) for the combination of input pixel values (Rin, Gin, and Bin) can be obtained using the three-dimensional LUT for each output color component. In a case where the input values, Rin, Gin, and

Bin each have 256 tones, LUT1 [256][256][256][3], which is a table for converting to 256 tones, is preferably used for Rout, Gout, and Bout. The LUT1 contains output values of a total of 16,777,216 combinations (256×256×256). Here the [3] at the end is an index that takes the value 0, 1, or 2 to represent the output color component. Color conversion is performed using the gamut mapping described above. Specifically, it is achieved by executing the following processing on each pixel of an image configured of RGB pixel values of the image data input in step S101.

$$Rout = LUT 1 [ Rin ] [ Gin ] [ Bin ] [ 0 ] \qquad ( Formula 13 )$$

$$Gout = LUT 1 [ Rin ] [ Gin ] [ Bin ] [ 1 ] \qquad ( Formula 14 )$$

$$Bout = LUT 1 [ Rin ] [ Gin ] [ Bin ] [ 2 ] \qquad ( Formula 15 )$$

Also, the index number indicating the value of each input color component of the LUT may be reduced from 256 to 16, for example. In this case, the values of the reduced grid may be determined by interpolation of table values or the like and a known method of reducing table size may be used.

Next, in step S203, from the image data obtained in step S201, the CPU 102 sets a first region used for setting the color conversion method of the image data and a second region not used for setting the color conversion method in an image corresponding to the image data. The first region is a region in which the same color is continuous for two pixels or more in the vertical direction and two pixels or more in the horizontal direction. Here, the same color may mean not strictly the same and allow a certain color difference range. For example, in an L*a*b* color system, the same color may be colors in a predetermined hue angle range using a certain color as a reference. The first region is not limited to being one connected region and may include a plurality of regions of different colors or the same color. Setting the first region may correspond to storing the position of the first region detected from the image data. Thus, setting the first region may also be referred to as detecting the first region or identifying the setting of the first region. Note that if we define the region that is not the first region in the image data as the second region, the setting of the first region naturally results in the setting of the second region. Thus, the target of setting may be only the first region. The information indicating the first region may be referred to as region information.

Setting the color conversion method in the present embodiment refers to generating a color conversion table for gamut mapping. Alternatively, this may include selecting a color conversion table. Setting the color conversion method may include generating a conversion formula or generating a color conversion table as in the present embodiment or may be any method that can set a method for performing color conversion.

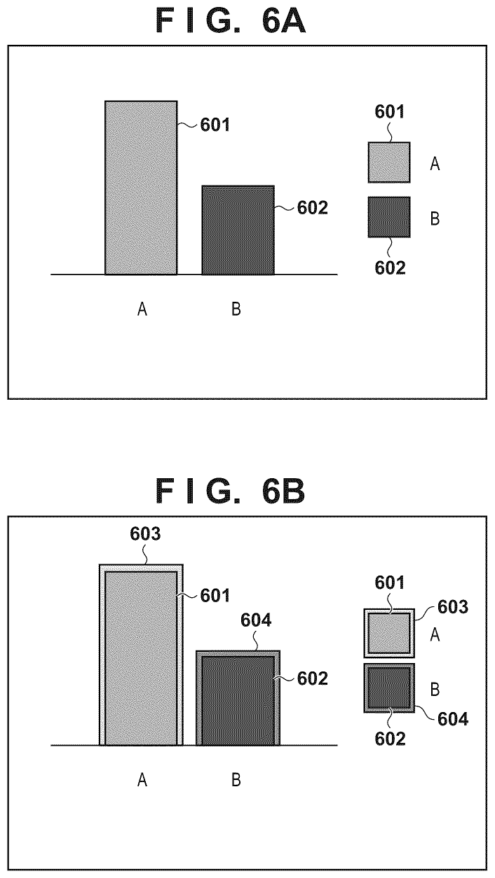

FIGS. 6A and 6B illustrate examples of image data obtained in step S201 according to the first embodiment. FIG. 6A illustrates an image of the document data generated for input to the image processing apparatus 101 by the user. FIG. 6B illustrates an image obtained by performing resolution conversion of the image data of FIG. 6A to a low resolution by simple decimation and thereafter performing resolution conversion back to the original resolution via bilinear conversion. In the image processing apparatus 101, due to the capacity limit of the storage medium 104 of the image processing apparatus 101, resolution conversion or compression may be performed on the input document data for storing in the storage medium 104, and then when the document data is to be used, the document data may be developed (reverse resolution conversion or decompressed) for use. In FIG. 6A, the graph has only two colors, color 601 and color 602. In FIG. 6B, in addition to the color 601 and the color 602, color 603 and color 604 have been generated by resolution conversion.

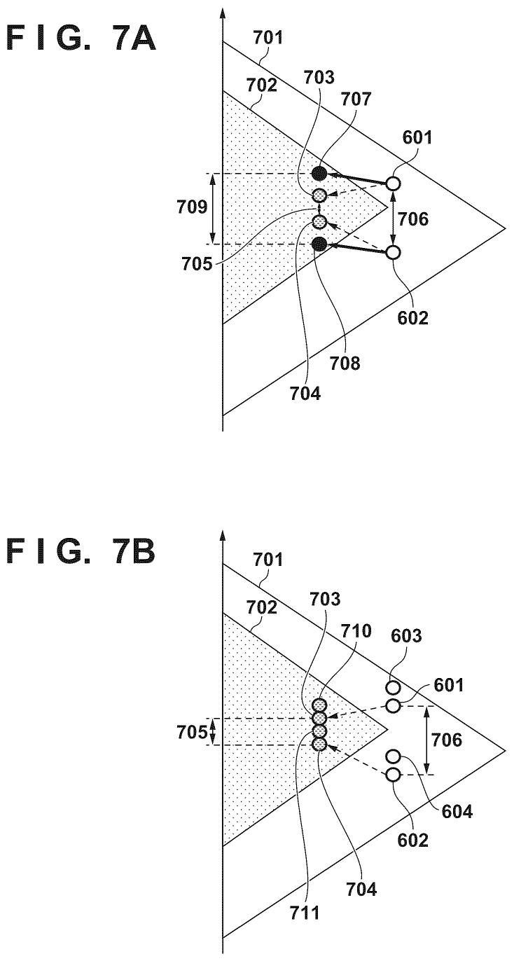

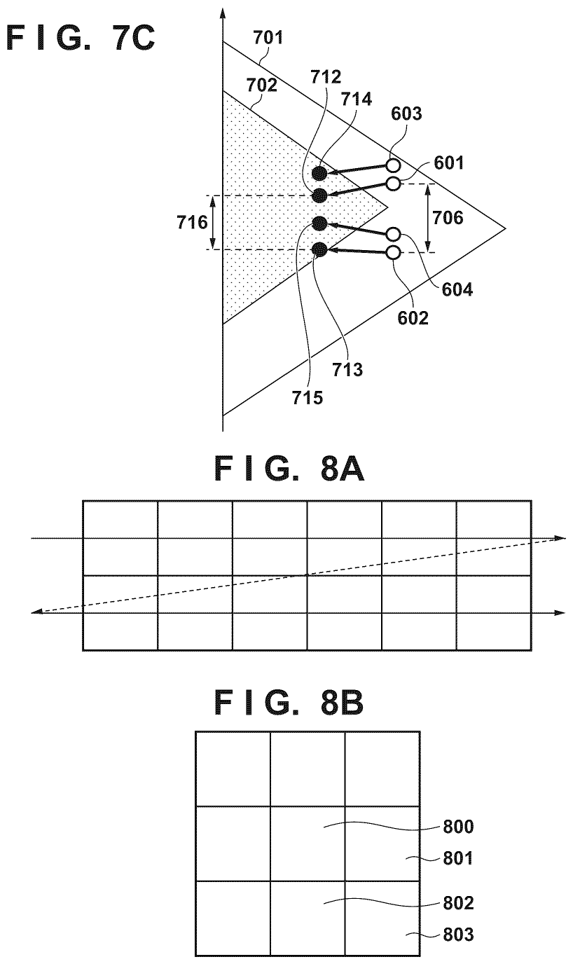

FIGS. 7A to 7C are diagrams for describing color degeneration and improvements thereto. FIG. 7A illustrates the image data before color conversion in the case of FIG. 6A, and FIGS. 7B and 7C illustrate the image data before color conversion in the case of FIG. 6B. In FIGS. 7A to 7C, a color reproduction region 701 is a color reproduction region of the image data that is the target of color conversion processing and is an sRGB color reproduction region in the present embodiment. A color reproduction region 702 is a color reproduction region after the color conversion processing of step S204 described below and corresponds to a color reproduction region in a predetermined output mode of the printing apparatus.

In FIG. 7A, color 703 is a color obtained by color conversion of the color 601 via color conversion processing (gamut mapping). Color 704 is a color obtained by color conversion of the color 602 via gamut mapping. A color difference ΔE705 between the color 703 and the color 704 is compared with a color difference ΔE706 between the color 601 and the color 602 and if smaller, color degeneration is determined. The method of calculating the color difference ΔE may include using the Euclidean distance in a color space. A preferred example according to the present embodiment in which the Euclidean distance in a CIE-L*a*b* color space (hereinafter referred to as the color difference ΔE) will be described. Since the CIE-L*a*b* color space is a perceptually uniform color space, the Euclidean distance can approximately correspond to the color change amount (color difference). Thus, when the Euclidean distance in the CIE-L*a*b* color space is small, a person perceives colors that are close to one another, and when large, a person perceives colors that are far away from one another. The color information in a CIE-L*a*b* color space is represented by the color space of the three axes, L*, a*, and b *. The calculation formula for the color difference ΔE between a color (L1, a1, b1) and a color (L2, a2, b2) is as follows.

$$ΔE = \sqrt{{( {L}_{1} - {L}_{2} )}^{2} + {( {a}_{1} - {a}_{2} )}^{2} + {( {b}_{1} - {b}_{2} )}^{2}} \qquad ( Formula 16 )$$

In the present embodiment, a color conversion table for correcting color degeneration by separating the distance between the color 703 and the color 704 in a predetermined color space is generated. Specifically, correction processing is executed to increase the distance between the color 703 and the color 704 to a distance equal to or greater than a distance at which the different colors can be identified by a person on the basis of their perceptual characteristics. Based on the perceptual characteristics, the distance between colors at which different colors can be identified corresponds to 2.0 or greater for the color difference ΔE. More preferably, the color difference between the color 703 and the color 704 is approximately equal to the color difference ΔE706. Thus, a color conversion table for gamut mapping the color 601 to color 707 and the color 602 to color 708 is generated. As a result, a color difference ΔE709 equal to the color difference ΔE706 can be reproduced in the device color gamut.

In FIG. 7B, color 710 is a color obtained by color conversion of the color 603 via gamut mapping. Color 711 is a color obtained by color conversion of the color 604 via gamut mapping. If the distance between colors is increased to correct color degeneration in a similar manner to as described above, as illustrated in FIG. 7C, a color conversion table for gamut mapping the color 601 to color 712, the color 602 to color 713, the color 603 to color 714, and the color 604 to color 713 is generated. Thus, though the distance between colors after color conversion is greater compared to FIG. 7B, in some cases, a color difference ΔE716 between the color 712 and the color 713 cannot be increased in the device color gamut to E2.0 or greater or to a value approximately equal to the color difference ΔE706. As a result, colors that are identifiable in the document data displayed on a monitor may be difficult to identify or be unable to be identified in the printing apparatus output result.

In the present embodiment, color information of image data identifiable by a person and discernible in the output of the printing apparatus is defined as color information of a region with an area equal to or greater than a predetermined area in a plane, and this region is set as the first region. Thus, in the image data, a region with pixels that continuously have the same color information for two pixels or more in the vertical direction and two pixels or more in the horizontal direction is set as the first region. Setting the first region corresponds to storing the position of an identified first region, for example. The color information may also be stored in association with a position.

### Setting the First Region

FIGS. 8A and 8B are diagrams for describing setting of the first region according to the present embodiment. As illustrated by arrows in FIG. 8A, in the present embodiment, via line processing, successive processing is executed on the image data configured of pixels arranged in a grid-like pattern on a pixel unit basis targeting from the first pixel of each line. Note that the arrangement of pixels in one direction in the image data with the pixels arranged in a grid-like pattern is referred to as a line or row, and the arrangement of pixels in a direction orthogonal to this line is referred to as a column. For example, a line may be an arrangement of pixels corresponding to the scanning direction of the print head 115 at the time of image formation.

In processing on a pixel unit basis, it is determination whether the color information of each of the three pixels (pixel 801, pixel 802, and pixel 803) surrounding a processing target pixel (target pixel) 800 illustrated in FIG. 8B is the same as the color information of the target pixel. If it is determined that they have the same color information, the four pixels including the target pixel are set as the first region. Pixels already set as the first region may be re-set as the first region via processing on a pixel unit basis.

The processing to set (or identify) the first region is executed along a line, in other words, while targeting pixels in order of raster scanning. Thus, if a 2×2 pixel region is identified as the first region, the next target pixel is a pixel included in the identified first region. This is illustrated in FIG. 8B, where the pixel 801 is included in the first region in which the pixel 800 is identified as the target pixel. Accordingly, if the first region is identified with the pixel 801 as the target pixel, the two identified first regions have the same color and thus may be joined as one first region. Because the scanning in one line for identifying the first region is performed in this manner, the first region can expand in the line direction. The color information of the identified first region may be stored in the RAM 103 or the like in association with the position information of the first region, for example. In the present embodiment, the first region is identified per line. Thus, in the present embodiment, the first region that can be identified by one line operation includes one or more rectangular regions with a height (Y direction) of two pixels and a length (X direction, raster scanning direction) of N pixels (2≤N≤number of pixels in the X direction of image data). Here, the position information of the first region may be represented by the position (LeftTop (x1, y1)) of the upper left pixel of the rectangle and the position (RightBottom (x2, y2) of the lower right pixel. By identifying the first region in this manner, the first regions included in one piece of image data may include a plurality of divided rectangular regions or overlapping rectangular regions identified as the first region. Each rectangular region forming a first region is referred to as a sub-region of the first region. Overlapping sub-regions have the same color information. Also separated sub-regions may have the same color information or different color information. In other words, in the first region identified from the image data in this manner, a plurality of rectangular sub-regions with a predetermined size (for example, 2×2 or more) are included, and the plurality of rectangular sub-regions may have different colors. Also, position information may be stored per sub-region, and color information may be stored per sub-region.

In the present embodiment, the first region is set using the method described above. However, the method is not necessarily limited to the method described above, and it is only required that a region with the same color information with a predetermined area or more in a plane can be extracted. Also, in the present embodiment, a region with the same color information is extracted. However, in other examples, in the original image data, for example, in irreversibly compressed image data such as JPEG, the same color information may vary within a predetermined range. Thus, a color determined as the same color information may be set with a variance range, such as being within a color difference ΔE of 1.0 or the RGB value difference being within a predetermined value. In a case where similar colors are determined to be the same color, it is particularly preferable that the hues are similar. For example, if the color difference between the two colors is within a predetermined tolerance range, in the case of a L*a*b* color system, it is preferable that the color difference is within a predetermined hue angle range, and in the case of an RGB color system, it is preferable that the two colors are on a straight line passing through the origin or close to being on the straight line. Thus, in addition to the color difference simply being in a certain range, the difference in hue being within a certain range may also be made a condition of being the same color.

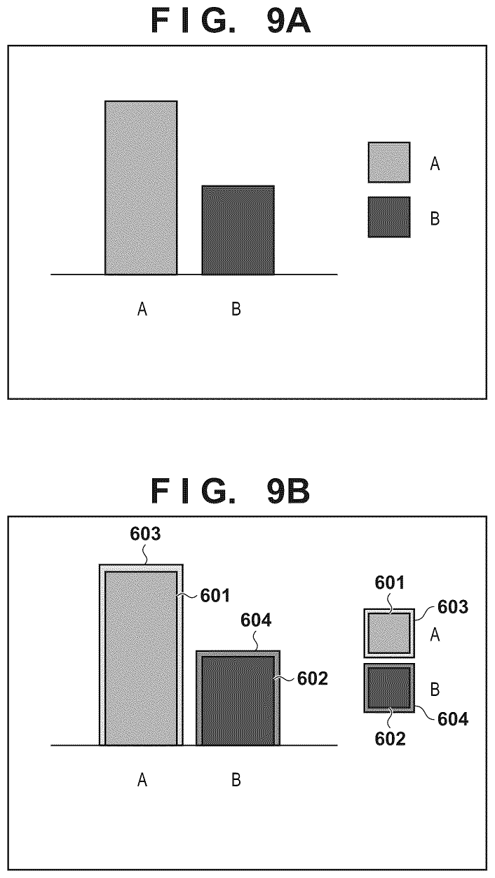

In the present embodiment, as the result of setting the first region, in the image data of either FIG. 6A or FIG. 6B, the regions colored in black in FIGS. 9A and 9B are set as the first region, and the region colored in white is set as the second region. In FIG. 9A, the regions corresponding to both a region 601 and a region 602 of FIG. 6A are set as the first region. In FIG. 9B also, the regions corresponding to both the region 601 and the region 602 of FIG. 6B are set as the first region. However, the regions corresponding to a region 603 and a region 604 are both not set as the first region.

Next, in step S204, the CPU 102 generates a color conversion table from the following information. In other words, in step S204, the color conversion method is set.
The image data obtained in step S201
The color conversion table stored in the storage medium in advance used in step S202
The image data color-converted using the color conversion table stored in the storage medium in advance in step S202
The region information set in step S203
   The color conversion table generated in step S204 is similar in format to the color conversion table stored in the storage medium in advance used in step S202.

Next, in step S205, the CPU 102 generates post-color-conversion image data (also referred to as output image data) by applying color conversion to the image data obtained in step S201 using the color conversion table generated in step S204. The generated image data is stored in the RAM or the storage medium.

### Setting of Color Conversion Method

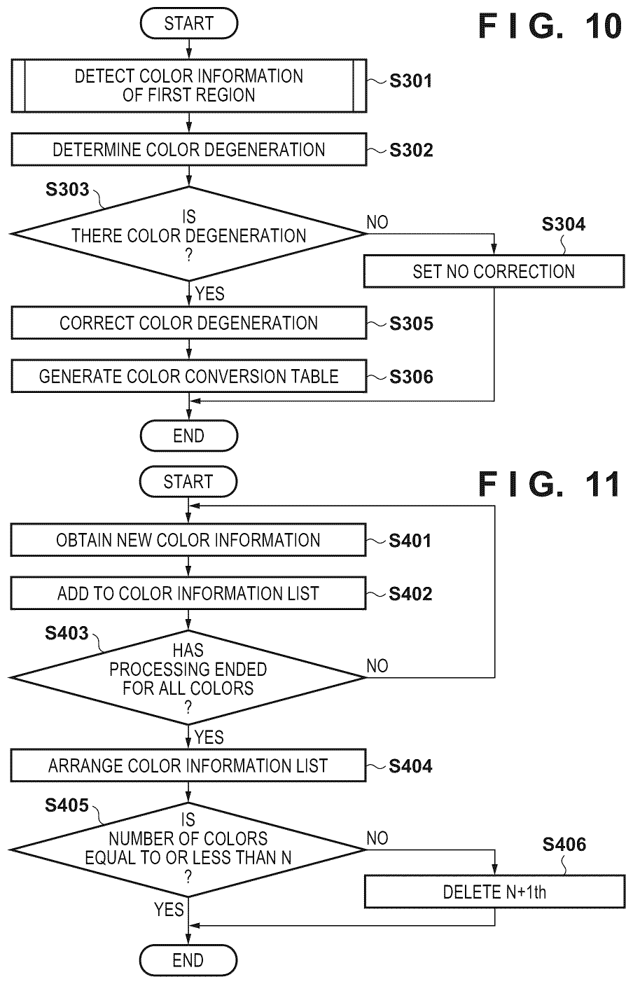

The method of generating a color conversion table for reducing color degeneration of step S204 will now be described in detail using the flowchart of FIG. 10. The processing of FIG. 10 is implemented by the CPU 102 executing a program loaded on the RAM 103, for example. In the present embodiment, an example is described in which the processing to generate a color conversion table is executed by the image processing apparatus 101. However, in other examples, the processing may be executed by the printing apparatus 108 or the processing may be shared between the image processing apparatus 101 and the printing apparatus 108.

In step S301, the CPU 102 detects the color information of the first region of FIGS. 8A and 8B set in step S203. The detection target is the image data obtained in step S201. From the detected color information, a color information list listing the colors included in the first region is generated. The detection processing is repeatedly executed for each pixel of the image data of the first region and for all pixels included in the image data of the first region. In the present embodiment, the color 601 and the color 602 of FIG. 6A or FIG. 6B are detected as the color information of the first region. Note that the color 603 and the color 604 are not the first region and are excluded from the color information list to prevent unnecessary color degeneration correction. The color information list is initialized at the start of step S301. Note that in step S203 of FIG. 5, in a case where the color information of the first region identified from the image data is stored, the color information may be made into a color information list. Also, step S203 of FIG. 5 may be omitted, and in step S301, the color information list may be generated in addition to the identification of the first region in step S203.

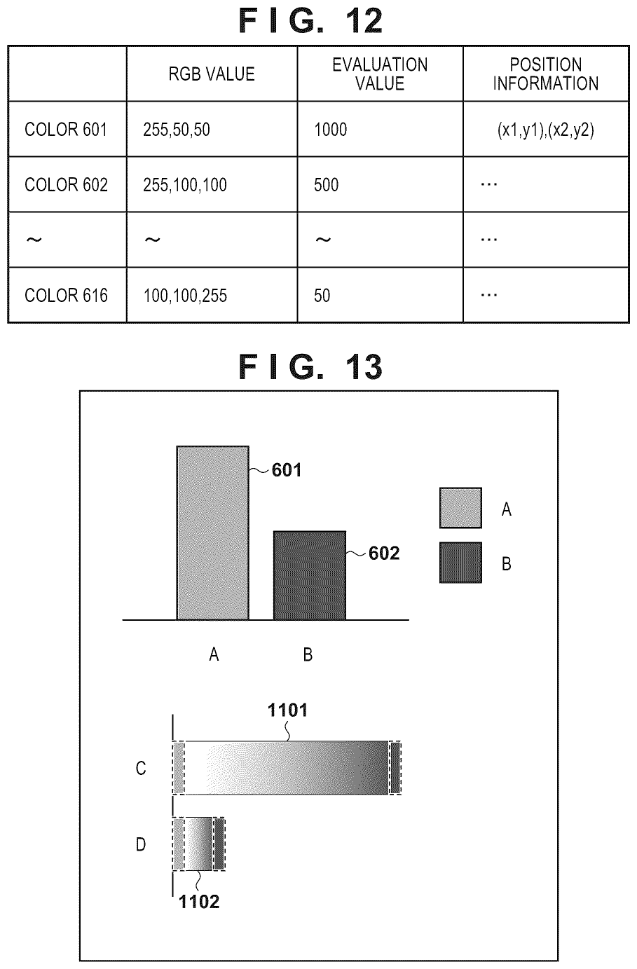

FIG. 11 is a flowchart illustrating step S301 in detail and illustrates a method of generating a color information list when new color information is detected as color information of the first region. FIG. 11 is a part of FIG. 10 and thus is implemented in a similar manner by the CPU 102 executing a program loaded on the RAM 103, as shown in FIG. 10. FIG. 12 is an example of a generated color information list. The list includes RGB values and evaluation values, with the evaluation values being arranged in descending order. Also, the position of at least one sub-region including corresponding color information may be stored in association with the color information. The position information can be obtained from the color information and the position information of the sub-region forming the first region identified in step S203.

In the present embodiment, the evaluation value corresponds to the number of pixels that has the same color information for each piece of color information included in the first region. In step S203 of FIG. 5, the first region is identified and the position information of each sub-region included in the first region is stored, making it easy to identify the number of pixels per sub-region. In particular, in the present embodiment, since the height of the sub-region is 2, this can be obtained using length (y2−y1+1)×2. The number of pixels can be obtained by finding the number of pixels of each piece of color information via integration for each piece of color information.

As described above, the sub-regions included in the first region may overlap. However, overlapping pixels may be identified from the position of the sub-regions and color information, and that number may be subtracted or the overlapping pixels may be included in the obtained number of pixels. If the overlapping pixels are included, a weighting according to the size is assigned to the region with the one consecutive color. For the evaluation value, instead of simply using the number of pixels, weighting may be assigned as described below. In the present embodiment, description will be given below assuming that the maximum number of colors in the color information list is 16.

In step S401 of FIG. 11, the CPU 102 obtains newly detected color information different from the color information already registered in the color information list. Thus, from among the sub-regions of the first region identified from the image data that is the target of the color conversion processing, a sub-region that has not been targeted in step S401 is targeted, and the color information of this sub-region is referenced and compared to the color information registered in the generated color information list. If the comparison result indicates different color information, the color information referenced in the target sub-region is obtained. If the same, the color information of the next unprocessed sub-region is referenced, and similar processing may be repeated. Note that in a case where color information is stored per sub-region in step S203 of FIG. 5, the stored color information is referenced, and processing similar to that described above is executed.

In step S402, the CPU 102 adds the color information newly obtained in step S401 to the color information list.

In step S403, the CPU 102 determines whether processing has ended for the color information of all of the first regions identified from the image data that is the target of the color conversion processing. In other words, for the sub-regions included in the first region, it is determined whether or not obtaining their color information and adding it to the color information list has ended. If there is an unprocessed color, the processing is repeated from step S401 for that color. In other words, if there is an unprocessed sub-region, the sub-region is targeted and the processing from step S401 is repeated.

In step S404, the CPU 102 obtains the evaluation value of each piece of color information registered in the color information list and arranges the color information list with the evaluation values in descending order. In other words, the color information is sorted with the evaluation values in descending order.

In step S405, whether or not the number of records included in the color information list, that is, the number of colors, is equal to or less than a predetermined threshold, that is, equal to or less than the maximum number of colors (for example, equal to or less than 16), is determined. If the number is equal to or less than the threshold, for example, equal to or less than 16 colors, the processing ends. On the other hand, in a case where the number is greater than the threshold, that is, greater than 16 colors, in step S406, the color information in order from one after the threshold, for example, from the 17th onward, is deleted from the list. Accordingly, regarding the color information equal to or greater than a predetermined number of colors, taking into consideration the processing time and storage capacity, the number of colors can be limited so that the colors with a greater number of pixels identifiable by a person and discernible in the printing apparatus output remain in the color information list and the target of setting the color degeneration correction can be restricted.

In step S302, the CPU 102 detects the number of combinations of colors showing color degeneration from among the combinations in the color information list on the basis of the color information list generated in step S301. For example, as described in step S203, a combination of the color 601 and the color 602 is detected to show degeneration.

Thus, for example, the color information of the color information list is sequentially targeted, the position information associated with the targeted color information is referenced, and the color information of the pixel corresponding to the position is obtained from the post-color-conversion image data stored after color conversion in step S202. Here, the color and information registered in the color information list and the post-color-conversion color information obtained from the position based on the position information of the color information are referred to as corresponding colors or corresponding color information. The obtained color information is stored in association with the corresponding color information included in the color information list. Then, pairs are formed for all color information registered in the color information list, and the color difference between the pairs is calculated. In the example described above, the registered color information has a maximum of 16 colors, and thus the number of combinations is ₁₆C₂=120. The color difference ΔE for each pair of color information is obtained (for example, the color difference 705 between the color 703 and the color 704 in FIGS. 7A to 7C). In a similar manner, pairs are formed of the post-color-conversion color information associated with each color information, and the color difference ΔE′ between these is obtained (for example, the color difference 706 between the color 601 and the color 602 in FIGS. 7A to 7C). Accordingly, the color difference ΔE between the color information registered in the color information list and a color difference ΔE′ between the color information obtained via color conversion of the color information are obtained, and these are associated together. The associated color differences ΔE and ΔE′ are compared. Then, if the color difference ΔE′ between the corresponding post-color-conversion color information is less than the color difference ΔE between the pre-color-conversion color information registered in the color information list (ΔE>ΔE′), it can be determined that the color information pair based on the color difference shows color degeneration.

Note that here, in a case where a pre-color-conversion color difference can be perceived with the naked eye, in other words, in a case where the pre-color-conversion color difference ΔE is greater than a predetermined value, a color degeneration determination may be made as described above.

Alternatively, without strictly comparing which is bigger or smaller, if the ratio of change in the color difference caused by the color conversion is less than a predetermined value, for example, it may be determined that there is enough color degeneration to require correction. In other words, take an example in which the color difference between a pair of certain colors after correction processing is ΔE′, and the color difference between the corresponding pair of colors before correction processing is ΔE. In this case, if ΔE′/ΔE≤Th (for example, Th=0.9 or the like), it may be determined that there is enough color degeneration to require correction. In this case, enough color degeneration to require correction may be simply referred to as color degeneration.

In step S303, the CPU 102 determines whether or not the number of combinations (color information pairs described above) of colors determined to be showing color degeneration in step S302 is zero. In a case where the number of combinations of colors showing color degeneration is zero, step S304 is moved to and the image data to be processed is determined to be image data that does not require color degeneration correction. Note that in a case where the number of colors registered in the color information list is one or less, a pair of colors cannot be made. Thus, the number of combinations of colors showing color degeneration is determined to be zero and color degeneration correction is determined to be not required.

In a case where color degeneration correction is determined to be not required, as the color conversion table, the color conversion table stored in the storage medium in advance used in the color conversion in step S202 is set as the color conversion table for the image data to be processed. In other words, it is set to use, as the color conversion method, the color conversion table stored in the storage medium in advance. Note that in this case, the image data obtained via the color conversion processing is the same as the image data generated in step S202. Here, in the subsequent step S205, color conversion processing may not be executed, and the image data generated in step S202 may be set as the post-color-conversion image data.

In a case where the number of combinations of colors showing color degeneration is not zero, step S305 is moved to and color degeneration correction is performed. In the color degeneration correction, the color conversion table stored in the storage medium in advance used in the color conversion in step S202 is corrected to generate a new color conversion table.

However, color degeneration correction changes colors. Unnecessary color changes may be caused when the color is changed in combinations of colors that do not show color degeneration. Thus, the need for color degeneration correction may be determined on the basis of the total number of combinations in the color information list and, of these, the number of combinations of colors showing color degeneration. Specifically, in a case where the number of combinations of colors showing color degeneration is the majority in the total number of combinations in the color information list, it may be determined that color degeneration correction is required. In this manner, the negative effects of color change due to color degeneration correction can be reduced. For example, in a case where the number of colors included in the color information list is 16 and thus all of the color combinations number 120, if the number of color combinations showing color degeneration is determined to be greater than 60, color degeneration correction is determined to be required.

In step S305, the CPU 102 performs color degeneration correction on the color combinations showing color degeneration on the basis of the image data obtained in step S201, the image data after the color conversion in step S202, and the color conversion table used in step S202. As described above in step S203, the color degeneration correction is performed by correcting the color conversion table so that the post-color-correction color difference ΔE705 between the color 703 and the color 704 is the same as the color difference ΔE709 between the color 707 and the color 708 that is similar to the corresponding pre-color-correction color difference ΔE706. The color degeneration correction processing is repeated the number of times corresponding to the number of color combinations showing color degeneration. The result of the color degeneration correction for the number of color combinations is stored in a table as pre-correction color information and post-correction color information. In FIGS. 7A to 7C, the color information is color information in a CIE-L*a*b* color space. Thus, the information may be converted into the color space of the image data at the time of input and the image data at the time of output. In this case, the pre-correction color information in the color space of the image at the time of input and the post-correction color information in the color space of the image data at the time of output are stored in a table. In FIGS. 7A to 7C, the post-correction colors 707 and 708 are separated in the brightness direction along an extension line from the color 703 to the color 704. However, the present embodiment is not limited to this. As long as the color difference ΔE709 between the color 707 and the color 708 is separated only by a distance corresponding to the color difference ΔE706, the direction in the CIE-L*a*b* color space may be any direction including the brightness direction, the chroma direction, or the hue angle direction. Also, instead of one direction, any combination of the brightness direction, the chroma direction, and the hue angle direction may be used. Also, FIGS. 7A to 7C illustrate an example in which both the color 703 and the color 704 are corrected. However, correction may be performed by correcting only one color to separate them a distance corresponding to the color difference ΔE706.

In step S306, the CPU 102 changes the color conversion table using the result of the degeneration correction of step S305. The pre-change color conversion table is a table for converting the color 601 of FIGS. 6A and 6B to the color 703 and the color 602 of FIGS. 6A and 6B to the color 704. Via the result of step S305, the table is changed to a table for converting the color 601 of FIGS. 6A and 6B to the color 707 and the color 602 of FIGS. 6A and 6B to the color 708. Accordingly, a post-color-degeneration-correction table can be generated. The color conversion table changing is repeated the number of times corresponding to the number of color combinations showing color degeneration. The color conversion table generated here is set as the color conversion table used in the color conversion processing of the image data to be processed.

Specifically, the colors 601 and 602 represented in L*a*b* are (L1, a1, b1) and (L2, a2, b2) respectively. Also, the colors 703 and 704 are (L1′, a1′, b1′) and (L2′, a2′, b2′) respectively, and the colors 707 and 708 are (L1″, a1″, b1″) and (L2″, a2″, b2″) respectively. In a pre-color-degeneration-correction color conversion table TBL, TBL (L1,a1,b1)=(L1′, a1′, b1′) and TBL (L2, a2, b2)=(L2′, a2′, b2′). Here, the post-color-degeneration-correction color conversion table TBL′ is generated so that TBL′ (L1,a1,b1)=(L1″, a1″, b1″) and TBL′ (L2, a2, b2)=(L2″, a2″, b2″). Note that the preparing of each component after conversion for the color conversion table is abbreviated here as a summary of all elements. Such correction is performed for all color information set as a target for color degeneration correction. Colors that are not set as targets for color degeneration correction may be left unchanged. Alternatively, for colors that are not targets of color degeneration correction and colors (color difference) in a predetermined range from a color that is targeted for color degeneration correction may be corrected via moving in parallel with the color targeted for color degeneration correction.

In the present embodiment described above, when color conversion processing is executed on image data, first, the first region is identified from the original image data to be processed. Here, the first region includes at least one sub-region, with the sub-regions each having a single color, and has a size equal to or greater than a predetermined size. In other words, the first region includes one or more colors. Also, of the colors included in the first region, a predetermined number of colors are identified according to a priority based on evaluation values. For each identified color difference of colors, on the basis of the change in color difference caused by the color conversion processing using a prepared (given) color conversion table, color degeneration correction is performed to reduce color degeneration for color combinations showing color degeneration, and a post-correction color conversion table is generated. The given color conversion table here is also referred to as a first color conversion table, and the post-color-degeneration-correction color conversion table is also referred to as a second color conversion table. The first color conversion table is a color conversion table prepared for converting the color information of the input color space to the color information of the output color space and may be referred to as a standard or default color conversion table. In a case where the number of colors included in the first region is 1, color degeneration correction is not required. Also, in the case of color degeneration, color conversion processing is executed on the original image data using the second color conversion table, and if not, the first color conversion table. Also, after the required processing, the post-processing image data is printed.

In this manner, compared to color conversion using the first color conversion table, color conversion using the second color conversion table results in an increase in the color difference between the color information of at least two colors from among the color information registered in the color information list, allowing color degeneration correction to be achieved. Also, the colors to be targeted for color degeneration correction can be limited to a certain number of colors, allowing the processing load to be reduced and color conversion processing to be quickly executed. By limiting the number of colors using the number of pixels of each color as an evaluation value, color degeneration correction can be more effectively performed targeting a region of a single color occupying a larger area.

### Modified Example of Present Embodiment

In the embodiment described above, in step S303 of FIG. 3, whether there is color degeneration with a combination of color information registered in the color information list is determined, and if there is a combination showing color degeneration, color degeneration correction is performed on the color information. This is determined using the number of colors registered in the color information list as a reference, and if the number of registered colors is 1 (or 1 or less), it may be determined to not perform color degeneration correction. If the number of registered colors is 2 or more, it may be determined to perform color degeneration correction. In this case, the color degeneration determination in step S302 may not be performed, or whether or not to perform color degeneration correction may be determined using only the number of colors as a reference. Also, in this case, in step S305, color degeneration correction may be performed to increase the color difference between colors registered in the color information list. At this time, color information not showing color degeneration may not be targeted for correction. This is the same as in the first embodiment. In other words, for combinations of color information registered in the color information list, if a post-color-conversion color difference is less than a pre-color-conversion color difference so that a combination of color information is showing color degeneration, this becomes the target of color degeneration correction. Conversely, combinations of color information not showing color degeneration do not become targets of color degeneration correction. As a result, in the present modified example also, color degeneration correction similar to that of the first embodiment described above can be performed and the same result can be obtained.

Also, as illustrated in FIGS. 9A and 9B, in the present embodiment, color information of image data identifiable by a person and discernible in the output of the printing apparatus is defined as a region with an area equal to or greater than a predetermined area in a plane, and this region is set as the color 601 and the color 602. Accordingly, the horizontal line at the lower portion of the bar graph in FIG. 6A or 6B is not detected. However, since this is not a target for setting the color degeneration correction, there is no need to apply the generated color conversion table described above. Also, in a case where FIG. 6B illustrates the image data of step S201, as illustrated in FIG. 9B, the color 603 and the color 604 are not the first region for generating a color conversion table for correction. Thus, unnecessary color degeneration correction can be prevented, and an optimal output image can be obtained.

According to the present embodiment, a first region used for setting the color conversion method of the image data and a second region not used for setting the color conversion method are set (or identified). By setting these regions, unnecessary color degeneration correction can be prevented, and an appropriate color conversion method can be set on the basis of only the information of the regions that require color degeneration correction. As a result, a color conversion result suitable for the printing apparatus can be obtained for the entire image. In the embodiment described above, the first region is identified. However, since the region in the image data that is not the first region corresponds to the second region, it can be said that the second region is also identified by identifying the first region.

In the present embodiment, color information of image data identifiable by a person and discernible in the output of the printing apparatus is defined as a region with a predetermined area in a plane, and this region is set as the first region under the condition that pixels with the same color information continue for two pixels or more in the vertical direction and for two pixels or more in the horizontal direction. However, the number of consecutive pixels in the vertical and horizontal direction may be set according to the output resolution of the printing apparatus, the perceptual characteristics of the person viewing the output of the printing apparatus, and the like. As a result, a more suitable first region can be set. Also, a setting condition for the first region may be designated by a user using the printing apparatus via the UI of the printing apparatus or information attached to the document data. As a result, the user's intention can be reflected in the setting condition for the first region. The setting condition may be size, for example, and may be designated by the number of pixels in the vertical and horizontal directions, for example.

Also, in the present embodiment, the color conversion table stored in the storage medium in advance is used in setting the color conversion table, and a color conversion table of the same format is generated. However, in the color conversion in step S202, the color conversion table stored in the storage medium may not be used, and a predetermined rule may be used to relatively convert a color to a color reproduction region of the printing apparatus from the color reproduction region of the obtained image data. As a result, there is no need to store the color conversion table in the storage medium in advance, allowing the storage capacity to be reduced. In this case, in color degeneration correction, a table may be generated in which a color corrected via color degeneration correction is associated with a color converted via the rule. When applying color conversion, after the color conversion of the image data using the rule described above, color correction processing may be executed according to the generated table. Also, in the setting of the color conversion method in step S204, without setting the color conversion table, the color information of before and after color conversion may be set in a dictionary format or may be set in a calculation formula if a calculation formula can bring them close to one another. As a result, the storage capacity for performing comparisons with the color conversion table and storing the color conversion method can be reduced.

Also, in step S201, the obtained document data may undergo resolution conversion and be compressed and then stored in the storage medium. In this case, the image processing apparatus 101 may be provided with a resolution conversion unit for converting the resolution. Also, in step S301, the first region may be identified by targeting stored post-resolution-conversion image data with a reduced number of pixels. In this manner, for example, by the target being image data with resolution converted to ¼ or ⅛, the number of colors can be expected to be reduced, allowing the number of colors to be targeted for color degeneration correction to be narrowed down. Also, by detecting the first region using image data converted to a low resolution, color can be quickly extracted from a wider area. For example, detecting a region with two consecutive pixels in the vertical direction and two consecutive pixels in the horizontal direction as illustrated in FIGS. 8A and 8B using image converted to ¼ resolution is the same as detecting a region with 5 to 8 consecutive pixels in the vertical direction and 5 to 8 consecutive pixels in the horizontal direction targeting image data that has not been resolution-converted. In a similar manner, in the case of targeting image data with ⅛ resolution, it is the same as extracting a region with 9 to 16 consecutive pixels in the vertical direction and 9 to 16 consecutive pixels in the horizontal direction targeting image data that has not been resolution-converted.

Also, in the present embodiment, the number of pixels is used as the evaluation value. However, the evaluation value for each color in the color information list may be obtained via the following formula, where score is the evaluation value and count is the number of pixels. Also, it is not necessary to apply weighting to all and weighting may be applied to only one or more.

$$Score = Count \times {W}_{p osition} \times {W}_{s h a p e} \times {W}_{n e i g h b o r} \times {W}_{native}$$

Here, Wₚₒₛᵢₜᵢₒₙ is weighting based on position. For example, in the case of the evaluation value for color information C, the coordinate information of the upper left and the lower right of the detected sub-region with the color information C is stored, weighting is applied so that the evaluation value is higher the closer to the position of the header and the footer in the document data. The header is located on the upper side of the image, and the footer is located on the lower side. The distance from the upper left coordinate position of the sub-region with the color information C to the upper side is evaluated, and the distance from the lower right coordinate position of the sub-region to the lower side is evaluated. Then, for the smaller distance, Wₚₒₛᵢₜᵢₒₙ is set so that smaller distances are given a greater weighting. Here, if the upper side and the lower side extend in the X direction, the distance described above is obtained in the direction orthogonal to the upper side and the lower side. In other words, regarding the Y component of the coordinate position, the distance described above may be found by obtaining the difference between the Y component (for example, 0) of the upper side position and the Y component of the lower side position. For example, Wₚₒₛᵢₜᵢₒₙ may be a value obtained by dividing, from among the distances from the lower right coordinate position of the first region to the lower side, the smaller value by a value half the length in the vertical direction of the page to be processed and then subtracting 1 from this value. Also, in a case where a plurality of weightings are obtained for Wₚₒₛᵢₜᵢₒₙ, the maximum value may be used.

Wₛₕₐₚₑ is weighting of the aspect ratio or shape of the sub-region with the color information C. In the present embodiment, weighting is applied so that the evaluation value is higher when the sub-region is closer to a square or a circle. Here, if (W>H), Wₛₕₐₚₑ=H/W, otherwise Wₛₕₐₚₑ=W/H. Accordingly, a weighting from 0 to 1 can be applied. Note that in this embodiment, a connection of pixels of a single color in the column direction of the image data is not taken into account, but if there is a sub-region of the same color in the column direction as well, this connection may also be set as a single sub-region. In this case, the connected sub-regions may also be connected to form a rectangle. If there is an unconnected portion in one of the connected sub-regions, this portion may be redefined as an independent sub-region.

W_{neighbor} is weighting for whether or not there is an adjacent region with the same color. In the present embodiment, the weighting of the sub-region with the color information C is applied so that the evaluation value of the color information C is higher when the sub-region overlaps or is adjacent to another sub-region with the color information C, and isolated colors are given a low evaluation value. Adjacency and overlapping of sub-regions may be determined on the basis of the position information (upper left and lower right) of the region. For example, for weighting in this manner, the total number of sub-regions of each color is obtained for all of the colors registered in the color information list, for example. Then, the total value is set as the denominator and the number of sub-regions, from among the sub-regions of each color, that have an adjacent or overlapping region is set as the numerator to find the ratio (adjacency ratio). This may be used as W_{neighbor}. However, the value is zero for colors that do not have an adjacent or overlapping region. Thus, for such colors, the weighting may be obtained by setting the number of adjacent or overlapping region to 1.

Wₙₐₜᵢᵥₑ is weighting for the percentage or density of the number of pixels with the same color. In the present embodiment, weighting is applied so that the evaluation value is higher for regions with a high purity formed of only one color and lower for regions including similar colors. When identifying the first region, this is a weighting in a case where a color with a color difference within a predetermined value is considered the same color, and in a case where a region of strictly the same color is identified as the first region, the weighting Wₙₐₜᵢᵥₑ may be set to 1. For example, the total number of pixels of the region (sub-region) associated with each piece of color information included in the color information list is obtained. From these, the number of pixels of each same color is further obtained, and from these, the maximum value is determined. Also, a value obtained by dividing the maximum value by the total number of pixels may be set as the Wₙₐₜᵢᵥₑ relating to the color.

By using at least one of the weightings described above, the target for setting the color degeneration correction can be narrowed down to color information occupying a more impactful region. Also this weighting may include the position of a region with a color that is a target of color degeneration correction, the shape thereof, whether or not there is an adjacent region, and whether or not the color that is the target of degeneration correction is a single color. Also, in a case where a portion of the weighting of Mathematical Formula 2 is used, the weighting of other unused weighting is set to 1.

Also, in step S301, a color with a close distance in the image data, not only a color close to the color 601 and the color 602, can be registered in the color information list as a single piece of color information with the regions merged. A similar color may be a close with a color difference with the colors 601 and 602 that is within a predetermined value. When registering a similar color in the list as a merged single piece of color information in step S301, x1, y1, x2, y2 indicating the position of the first region is also set as the position of the first region including the similar and not only count. Thus, the regions of the reference color and the similar color are merged. The formula for when merging similar colors a and b is as follows.

$$Count = Count\_a + Count\_b$$

$$X 1 = min ( x 1 a , x 1 b )$$

$$Y 1 = min ( y 1 a , y 1 b )$$

$$X 2 = max ( x 2 a , x 2 b )$$

$$Y 3 = max ( y 2 a , y 2 b )$$

Here, Count_a and Count_b are the number of pixels of the sub-region of the color a and the color b, respectively. min(a,b) is a function where the value is the minimum value of both parameters, and max(c,d) is a function where the value is the maximum value of both parameters. In this manner, the target for setting the color degeneration correction can be limited. Also, for color information with a tiny number of pixels less than a predetermined number of pixels, an effect of being identifiable by a person and discernible in the output of a printing apparatus is minimal in setting the color conversion method in step S302 onward. Thus, such color information may be deleted from the color information list. In this manner, the negative effects of color change due to color degeneration correction can be reduced.

Also, the color information of two or more colors registered in the color information list may be merged, determination of whether or not color degeneration correction is required may be performed, and color degeneration correction may be performed. In this case, if two or more colors registered in the color information list are colors with only a color difference of a predetermined value or less, the colors are considered one color and merged. Then, color degeneration is determined on the basis of a change in the color difference caused by color conversion between the post-merge color and the other color. In this manner, color degeneration correction may be performed using the number of colors further reduced from the number of colors registered in the color information.

### Second Embodiment

In an example of the first embodiment described above, to appropriately perform color conversion on image data, a color conversion method is set on the basis of information of the first region required in color conversion. However, when the set color conversion method is applied to the image, a region with reduced image quality may be produced by the set color conversion method.

FIG. 13 is an example of image data obtained in step S201 according to the second embodiment. In addition to the image data of FIG. 6A, under the image data in FIG. 13, a region 1101 and a region 1102, which are horizontal bar graphs, are illustrated. Gradation in the horizontal direction is illustrated in both of the bar graphs, the region 1101 and the region 1102. To facilitate description, the left end of the region is the color 601 of FIGS. 6A and 6B and the right end is the color 602, and pixels form a gradation continuously between the color 601 and the color 602 with changing brightness.

In a case where the color conversion table stored in the storage medium in advance in step S202 of the first embodiment is applied to the region 1101 of FIG. 13, a smooth gradation between the color 703 and the color 704 of FIG. 7A is output from the printing apparatus. In a case where the color conversion table for reducing color degeneration generated in step S306 of the first embodiment is applied to the region 1101 of FIG. 13, a gradation between the color 707 and the color 708 of FIG. 7A is output from the printing apparatus. In this case, if a color included in the gradation region is not the target of color degeneration correction, the color difference between the color 707 and the color 708 at the end portions of the gradation and the colors transitioning to these colors is increased. In a case where a color forming the gradation is the target of color degeneration correction, the number of colors included in the first region increases, and all of the colors forming the gradation become unable to be included in the color information list. In this case, either color degeneration correction is not applied to all of the colors forming the gradation or color degeneration correction is applied to a portion of the colors, causing a degradation of image quality in the gradation portion. In this manner, for example, in a case where a color conversion table emphasizing the discernibility of colors is set, the image quality may be degraded in a region that emphasizes color continuity (tone).

Thus, in the present embodiment, to reduce image quality degradation, the color 601 and the color 602, which are color information in a region emphasizing the tone characteristics forming the gradation, are deleted from the color information list in the setting of the color conversion method of step S302 onward. In this manner, the negative effects of color change due to color degeneration correction can be reduced.

Color information in a region emphasizing tone characteristics forming the gradation can be detected or identified by the following method, for example. For example, in order of evaluation value, that is, order of priority, the colors included in the color information list generated according to the first embodiment are targeted, and the color difference between the color and the color of an adjacent pixel in a predetermined direction (adjacent pixel) in a sub-region of the color is obtained from the image data color-converted in step S202. If the color difference is within a predetermined value, a region in which the adjacent pixel and the same color pixel are connected is identified. If the length of the region in the predetermined direction described above is within a reference value, the color of the adjacent pixel is stored, and the color difference between the region and the adjacent pixel is obtained. This operation is repeated until the obtained color difference is greater than the predetermined value or until the length in the predetermined direction of the same color as the adjacent pixel is greater than the reference value. The color stored in this manner is set as a color forming the gradation, and the color is deleted from the color information list. However, for a color of an adjacent pixel at the time when processing ends, it can be determined that it is not a color forming the gradation and thus may not be targeted for deletion.

According to the present embodiment described above, a gradation region is detected, and color information forming a gradation region is removed from being a target of color degeneration correction. This can reduce a decrease in image quality in the gradation portion and can reduce a decrease in the continuity of color change in particular.

The present disclosure has been described above using embodiments. However, the technical scope of the present disclosure is not limited to the scope described in the embodiments. It should be clear to one skilled in the art that various changes and enhancement can be made to the embodiments described above. Embodiments including such changes and enhancement are included in the technical scope of the present disclosure as is clear from the claims.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-085653, filed May 27, 2024 which is hereby incorporated by reference herein in its entirety.

What is claimed is:

1. An image processing apparatus comprising:
at least one memory storing instructions; and
at least one processor that is in communication with the at least one memory and that, when executing the instructions, cooperates with the at least one memory to execute processing, the processing including
detecting, from image data, one or more regions each of which has a predetermined size configured by pixels of the same color,
storing color information of the color included in each of the one or more regions detected, and
generating output image data by performing color conversion of the image data using a first color conversion table in a case where the color information stored indicates one color, and generating output image data by performing color conversion of the image data using a second color conversion table in a case where the color information stored indicates two or more colors, wherein color conversion using the second color conversion table results in a larger color difference between at least two colors in the color information than color conversion using the first color conversion table.

2. The image processing apparatus according to claim 1, wherein
the number of colors of the color information stored is equal to or less than a predetermined maximum number of colors.

3. The image processing apparatus according to claim 2, wherein
the storing includes storing, from among the color information detected, color information of the predetermined maximum number of colors sorted by evaluation value for each color information in descending order on the basis of the evaluation value.

4. The image processing apparatus according to claim 3, wherein
the storing includes storing color information of the predetermined maximum number of colors with the evaluation value corresponding to the number of pixels for each color included in the one or more regions.

5. The image processing apparatus according to claim 3, wherein
the storing includes storing color information of the predetermined maximum number of colors with the evaluation value corresponding to a value obtained by applying a predetermined weighting to the number of pixels for each color included in the one or more regions.

6. The image processing apparatus according to claim 5, wherein
the predetermined weighting includes at least one of, regarding a region of each color included in the one or more regions, closeness to upper side or lower side of the image data, closeness to a square shape of a region for each color, closeness between regions for each color, and maximum value of a ratio of the number of pixels with the same color included in a region for each color.

7. The image processing apparatus according to claim 1, wherein
color information in which the color difference is larger when using color conversion using the second color conversion table compared to when using color conversion using the first color conversion table is color information that shows color degeneration when using color conversion using the first color conversion table.

8. The image processing apparatus according to claim 1, wherein
the processing further includes
reducing the number of pixels by performing resolution conversion on input image data, wherein
the image data is image data obtained by reducing the number of pixels of input image data.

9. The image processing apparatus according to claim 1, wherein
the pixels of the same color include pixels with a color difference within a predetermined tolerance range, and
from among the color information, color information with a color difference equal to or less than a predetermined value are merged to form color information.

10. The image processing apparatus according to claim 1, wherein
the processing further includes
detecting a gradation region, wherein
color information in which color conversion using the second color conversion table results in a larger color difference than color conversion using the first color conversion table does not include color information included in a gradation region.

11. A non-transitory computer-readable storage medium storing a program that causes a computer to execute an image processing method, the image processing method comprising:
detecting one or more regions each of which has a predetermined size configured by pixels of the same color from image data,
storing color information of a color included in each of the one or more regions detected, and
generating output image data by performing color conversion of the image data using a first color conversion table in a case where the color information stored indicates one color, and generating output image data by performing color conversion of the image data using a second color conversion table in a case where the color information stored indicates two or more colors, wherein color conversion using the second color conversion table results in a larger color difference between at least two colors in the color information than color conversion using the first color conversion table.

12. An image processing method comprising:
detecting one or more regions each of which has a predetermined size configured by pixels of the same color from image data,
storing color information of a color included in each of the one or more regions detected, and
generating output image data by performing color conversion of the image data using a first color conversion table in a case where the color information stored indicates one color, and generating output image data by performing color conversion of the image data using a second color conversion table in a case where the color information stored is two or more colors, wherein color conversion using the second color conversion table results in a larger color difference between at least two colors in the color information than color conversion using the first color conversion table.
